(19) United States
(12) Patent Application Publication
(10) Pub. No.: US 2025/0093673 A1
(43) Pub. Date: Mar. 20, 2025

(54) LENS ASSEMBLY

(71) Applicant: Changzhou AAC Raytech Optronics Co., Ltd., Changzhou City (CN)

(72) Inventors: Tongming Xu, Changzhou (CN); Suohe Wei, Changzhou (CN); Heqing YANG, Changzhou (CN)

(21) Appl. No.: 18/402,694

(22) Filed: Jan. 2, 2024

Related U.S. Application Data
(63) Continuation of application No. PCT/CN2023/119730, filed on Sep. 19, 2023.

(51) Int. Cl. G02B 27/64; G02B 7/02; G02B 7/08

(52) U.S. Cl. CPC G02B 27/646; G02B 7/028; G02B 7/08

(57) ABSTRACT

A lens assembly including a support base; a lens barrel suspended at an inner side of the support base; and an adjustment mechanism including an Auto Focus (AF) assembly, an Optical Image Stabilizer (OIS) assembly, an elastic sheet assembly, and a flexible connection plate disposed below the support base. The OIS assembly includes an OIS circuit board disposed between the support base and the flexible connection plate. A sensor is provided at a center of the OIS circuit board. The flexible connection plate includes a first connection portion connected to the sensor. The lens assembly allows an overall structure of the lens assembly more compact, thereby reducing moving parts and improving a service life and control precision of the lens assembly. The flexible connection plate and the sensor improve the heat dissipation effect of the sensor and enhances an overall strength of the elastic structure of the lens assembly.

### CROSS-REFERENCE TO RELATED APPLICATIONS

This application is a continuation of International Application No. PCT/CN2023/119730, filed on Sep. 19, 2023, which is hereby incorporated by reference in its entirety.

### TECHNICAL FIELD

The present disclosure relates to the field of optical imaging technology, and in particular, to a lens assembly.

### BACKGROUND

With the development of camera technology, a lens assembly with Auto Focus (AF) and Optical Image Stabilizer (OIS) have been widely applied in electronic devices such as tablets and smartphones. During operation, a certain amount of heat is generated in the lens assembly. In existing technology, usually a metal housing is used for heat dissipation. However, this technology has a low heat dissipation rate, which leads to an increase in the temperature of the lens assembly and a decrease in the operational performance. Moreover, in the exiting technology, a wire-suspended OIS assembly has a relatively short service life, and the installation of multiple parts on the moving portions directly affects the adjustment precision of AF and OIS of the lens assembly.

In view of this, it needs to provide a lens assembly with superior heat dissipation effect, enhanced adjustment precision and long service life.

### SUMMARY

In an aspect, the present disclosure provides a lens assembly, including a support base; a lens barrel suspended at an inner side of the support base; and an adjustment mechanism including an Auto Focus (AF) assembly, an Optical Image Stabilizer (OIS) assembly, an elastic sheet assembly, and a flexible connection plate disposed below the support base. The OIS assembly includes an OIS circuit board disposed between the support base and the flexible connection plate; a sensor is provided at a center of the OIS circuit board; and the flexible connection plate includes a first connection portion connected to the sensor.

As an improvement, a heat dissipation hole is formed in the first connection portion, and a first flexible connection structure is provided in the heat dissipation hole. The flexible connection plate further includes a first frame arranged at a periphery of the first connection portion, and a second connection portion arranged between the first frame and the first connection portion.

As an improvement, the OIS circuit board is a planar FPC, and the flexible connection plate is made of a titanium-copper alloy material.

As an improvement, the AF assembly includes an AF coil, an AF magnet and an AF circuit board. The OIS assembly further includes an OIS magnet and an OIS coil. The support base has a mounting groove, and the AF magnet, the OIS magnet and the OIS coil are arranged in the mounting groove along a direction from top to bottom. The AF coil is wound at a periphery of the lens barrel, and the AF circuit board is arranged at the support base.

As an improvement, the elastic sheet assembly includes a first elastic sheet and a second elastic sheet arranged on an upper surface and a lower surface of the lens barrel, respectively; and each of the first elastic sheet and the second elastic sheet is connected to both the lens barrel and the support base. The elastic sheet assembly is connected to the AF circuit board, the OIS assembly and the support base, respectively.

As an improvement, the AF magnet is arranged between the lens barrel and the support base, and the AF magnet is evenly distributed at a periphery of the lens barrel. The lens barrel includes a first connection ring arranged at a center, and a cantilever distributed at a periphery of and at an outer wall of the first connection ring; and the cantilever is arranged corresponding to four corners of the support base. A second flexible connection structure is provided between the cantilever and the support base.

As an improvement, a portion of the cantilever adjacent to the support base is provided with an avoiding structure.

As an improvement, the OIS magnet and the OIS coil are arranged corresponding to the AF magnet, respectively; an OIS support is provided in a plane region enclosed by the OIS coil, and the OIS support is arranged at the OIS circuit board. The OIS support includes a second connection ring arranged at a periphery of the sensor, a first contact table connected to the second connection ring and arranged corresponding to the OIS coil, and a second contact table extending from the second connection ring to a region corresponding to a bottom of the support base.

As an improvement, the first elastic sheet and the second elastic sheet have a same structure, which includes a third connection ring connected to the first connection ring, a first connection arm connected between the first connection ring and the support base, and a second connection arm connected between the first connection ring and the cantilever.

As an improvement, the lens assembly further includes a housing. The housing includes a first housing arranged outside the support base, and a second housing arranged below the first housing and configured to receive the OIS circuit board and the flexible connection plate; and a gasket is provided between the second housing and an edge of the flexible connection plate.

### BRIEF DESCRIPTION OF DRAWINGS

FIG. 1 is a schematic structural diagram of a lens assembly according to an embodiment of the present disclosure;

FIG. 2 is a sectional view taken along A-A in FIG. 1;

FIG. 3 is an exploded view of a lens assembly according to an embodiment of the present disclosure;

FIG. 4 is an assembly diagram of a flexible connection plate;

FIG. 5 is a schematic structural diagram of a first elastic sheet;

FIG. 6 is an enlarged view of a region A in FIG. 5; and

FIG. 7 is a schematic structural diagram of an OIS support.

### REFERENCE SIGNS

1. support base;
2. lens barrel;
   21. first connection ring;
   22. cantilever,
      221. avoiding structure;
3. AF assembly;
   31. AF coil;
   32. AF magnet;
   33. AF circuit board;
4. OIS assembly;
   41. OIS circuit board;
   42. OIS magnet;
   43. OIS coil;
   44. OIS support;
      441. second connection ring;
      442. first contact table;
      443. second contact table;
5. elastic sheet assembly;
   51. third connection ring;
   52. first connection arm;
   53. second connection arm;
6. flexible connection plate;
   61. first connection portion;
      611. heat dissipation hole;
   62. first frame;
   63. second connection portion;
7. sensor,
8. housing;
   81. first housing;
   82. second housing;
9. gasket.

### DESCRIPTION OF EMBODIMENTS

The present disclosure will be further described below with reference to the accompanying drawings and embodiments.

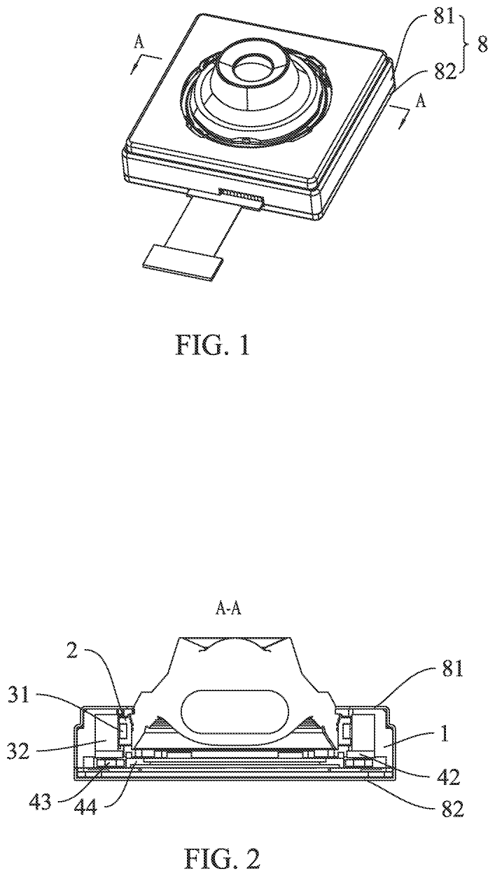

As shown in FIG. 1 to FIG. 3, a lens assembly of the present disclosure includes a support base 1, a lens barrel 2 and an adjustment mechanism. The lens barrel 2 is suspended at an inner side of the support base 1. The adjustment mechanism includes an AF assembly 3, an OIS assembly 4, an elastic sheet assembly 5, and a flexible connection plate 6 provided below the support base 1. The OIS assembly 4 includes an OIS circuit board 41 disposed between the support base 1 and the flexible connection plate 6. A sensor 7 is provided at a center of the OIS circuit board 41. The flexible connection plate 6 includes a first connection portion 61 connected to the sensor 7.

In an embodiment, the sensor 7 may be an IMX989 sensor.

The lens assembly of the present disclosure includes the flexible connection plate 6, which is arranged below the OIS circuit board 41 and connected to the sensor 7 that is arranged on the OIS circuit board 41. During use, the flexible connection plate 6 has elasticity to provide support for the parts arranged on the flexible connection plate 6, and also offer a restoring force for adjustment of the lens barrel 2. In the present disclosure, the wire-suspended part in the related art is replaced by the flexible connection plate 6, so that an overall structure of the lens assembly more compact, thereby reducing the arrangement of moving parts, and improving the service life and the control precision of the lens assembly. In addition, the corresponding arrangement of the flexible connection plate 6 and the sensor 7 improves the heat dissipation effect of the sensor 7, and enhances the overall strength of the elastic structure of the lens assembly, thereby improving the durability of the lens assembly, and prolonging the service life of the lens assembly. The improvement of the heat dissipation effect reduces an influence of the temperature rise of the lens assembly on the imaging effect, and decreases image noise, thereby enhancing image clarity and improving imaging quality.

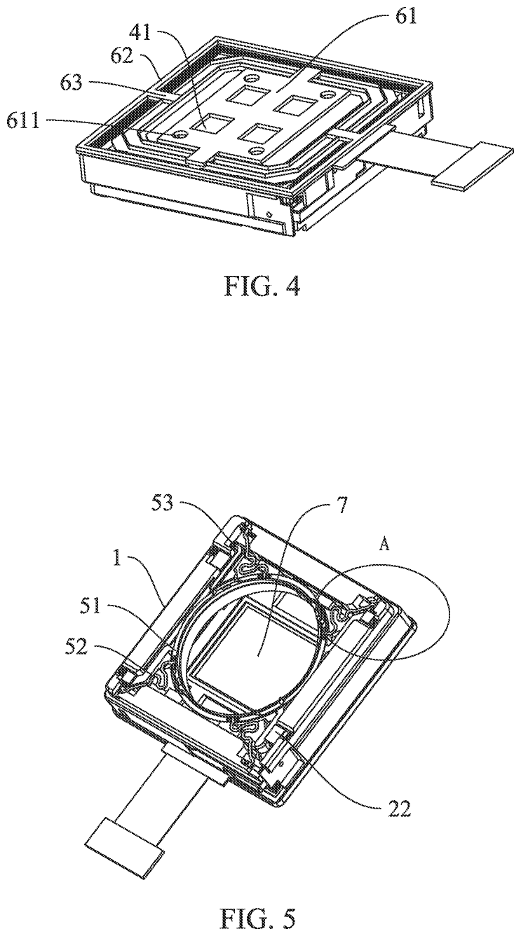

As shown in FIG. 4, a heat dissipation hole 611 is formed in the first connection portion 61, and a first flexible connection structure is arranged in the heat dissipation hole 611. The flexible connection plate 6 further includes a first frame 62 arranged at a periphery of the first connection portion 61, and a second connection portion 63 arranged between the first frame 62 and the first connection portion 61.

The first frame 62 is arranged corresponding to an edge of the OIS circuit board 41. In other embodiments of the present disclosure, the flexible connection plate 6 may further include a reinforced frame disposed between the first frame 62 and the first connection portion 61, and a third connection portion for connecting with the reinforced frame. The reinforced frame is disposed at a periphery of the first connection portion 61. The arrangement of the reinforced frame improves the support performance of the flexible connection plate 6, thereby improving the overall stability of the lens assembly.

In an example, the OIS circuit board 41 has a first mounting hole for mounting the sensor 7, and the first connection portion 61 is disposed corresponding to the first mounting hole, that is, the sensor 7 is projected to the first connection portion 61. In an example, the first flexible connection structure is formed by a heat dissipation adhesive filled in the heat dissipation hole 611; and the first flexible connection structure not only can play a role in heat dissipation, but also provides a damping effect, thereby further improving stability and control precision of the lens assembly.

In an example, the OIS circuit board 41 may be a planar flexible printed circuit board (FPC) to reduce a thickness of the OIS circuit board 41. In an example, the flexible connection plate 6 is made of a titanium-copper alloy material with high strength, high elasticity, heat resistance, excellent fatigue resistance and good bending performance, thereby improving the overall strength, recovery performance and fatigue resistance of the lens assembly, and thus ensuring the stability of the automatic adjustment function of the lens assembly.

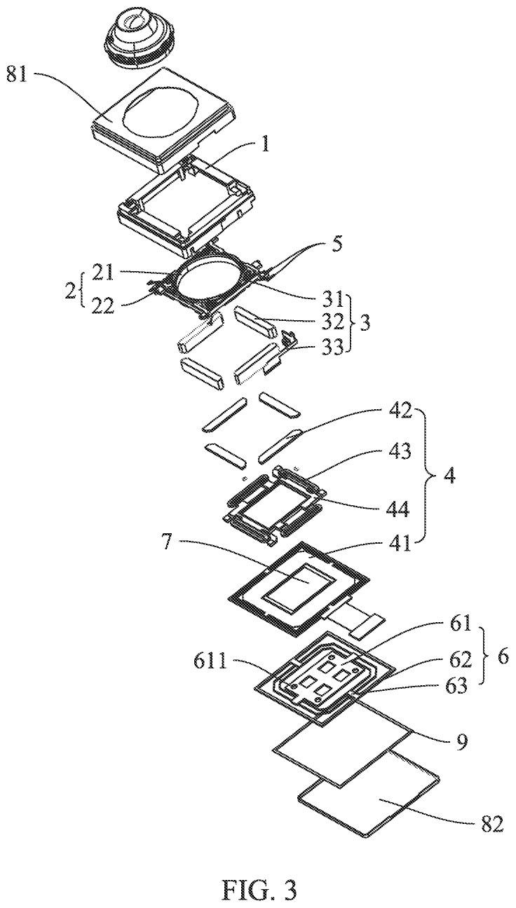

As shown in FIG. 2 and FIG. 3, the AF assembly 3 includes an AF coil 31, an AF magnet 32 and an AF circuit board 33. The OIS assembly 4 further includes an OIS magnet 42 and an OIS coil 43. The support base 1 has a mounting groove which opens inwards. The AF magnet 32, the OIS magnet 42 and the OIS coil 43 are arranged in the mounting groove along a direction from top to bottom. The AF coil 31 is wound at the periphery of the lens barrel 2, and the AF circuit board 33 is disposed at the support base 1. With such an arrangement, the space of the support base is fully utilized, resulting in a compact overall layout, thereby enhancing the integrity of the parts of the lens assembly, and reducing an overall volume of the lens assembly.

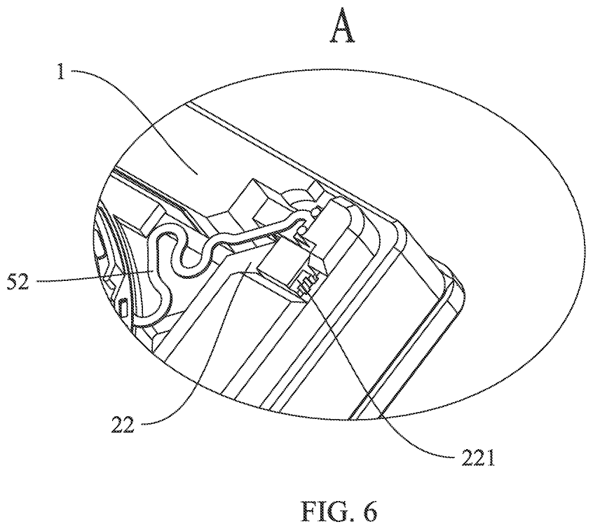

As shown in FIG. 3 and FIG. 5, the elastic sheet assembly 5 includes a first elastic sheet and a second elastic sheet that are arranged at an upper surface and a lower surface of the lens barrel 2, respectively, and each of the first elastic sheet and the second elastic sheet is connected to both the lens barrel 2 and the support base 1. The elastic sheet assembly 5 is connected to the AF circuit board 33, the OIS assembly 4 and the support base 1, respectively, to achieve closed-loop control for AF.

A center of the support base 1 has a second mounting hole, and the second mounting hole and the first mounting hole are coaxially arranged. The lens barrel 2 is suspended in the second mounting hole. It should be noted that a direction “upward” herein refers to a direction away from a base, and a direction “downward” refers to a direction adjacent to the base.

The AF magnet 32 is arranged between the lens barrel 2 and the support base 1, and the AF magnet 32 is evenly distributed at a periphery of the lens barrel 2. At least one AF magnet 32 is provided. In this embodiment, four AF magnets 32 are provided, and the four AF magnets 32 are arranged in two pairs (with each pair of AF magnets facing each other) at the periphery of the lens barrel 2. The lens barrel 2 includes a first connection ring 21 disposed at a center and configured to mount a lens, and a cantilever 22 disposed at a periphery of and at an outer wall of the first connection ring 21. The cantilever 22 is disposed corresponding to four corners of the support base 1. A second flexible connection structure is provided between the cantilever 22 and the support base 1. In an example, the second flexible connection structure includes a flexible adhesive structure formed by filling damping adhesive.

As shown in FIG. 6, a portion of the cantilever 22 adjacent to the support base 1 is provided with an avoiding structure 221. During use, the avoiding structure 221 provides an avoiding space for movement of the cantilever 22 relative to the support base 1 in a process of an up-and-down movement of the lens barrel 2 along an optical axis direction, thereby avoiding impact of the cantilever 22 and the support base 1, and thus ensuring the adjustment stability of the lens assembly.

In an embodiment, the avoiding structure 221 may be an avoiding step disposed at an upper surface of an end portion of the cantilever 22 adjacent to the support base 1.

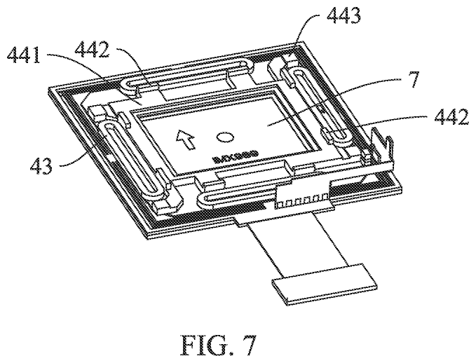

As shown in FIG. 2 and FIG. 7, the OIS magnet 42 and the OIS coil 43 are arranged corresponding to the AF magnet 32, respectively, an OIS support 44 is arranged in a plane region surrounded by the OIS coil 43, and the OIS support 44 is disposed at the OIS circuit board 41. The OIS support 44 includes a second connection ring 441 disposed at a periphery of the sensor 7, a first contact table 442 connected to the second connection ring 441 and arranged corresponding to the OIS coil 43, and a second contact table 443 extending from the second connection ring 441 to a region corresponding to a bottom of the support base 1. The first contact table 442 is configured to abut against an interior of the OIS coil 43 and prevent the lens barrel 2 from rotating on a plane perpendicular to the optical axis. The second contact table 443 is configured to abut against the bottom of the support base 1.

As shown in FIG. 5, the first elastic sheet and the second elastic sheet have a same structure, which includes a third connection ring 51 connected to the first connection ring 21, a first connection arm 52 connected between the first connection ring 21 and the support base 1, and a second connection arm 53 connected between the first connection ring 21 and the cantilever 22.

In some embodiments, at least two first connection arms 52 are provided. In this embodiment, four first connection arms 52 are provided. The first connection arms 52 are evenly distributed at a periphery of the third connection ring 51, thereby improving an anti-shake effect and recover stability of the lens assembly. At least one second connection arm 53 is provided. The first connection arm 52 is a flexible connection arm. In an example, the first connection arm 52 is of a spiral-snake-like structure, which can improve the deformation performance and the anti-shake and recover effect and the response effect of the first connection arm 52.

As shown in FIG. 1 to FIG. 3, the lens assembly further includes a housing 8. The housing 8 includes a first housing 81 arranged outside the support base 1, and a second housing 82 arranged below the first housing 81 and configured to receive the OIS circuit board 41 and the flexible connection plate 6. A gasket 9 is provided between the second housing 82 and an edge of the flexible connection plate 6.

The lens assembly further includes a lens disposed at the first connection ring 21 of the lens barrel 2.

The above description merely describes some of, rather than all of embodiments of the present disclosure, and it can be understood that those skilled in the art can further make improvements without departing from a concept of the present disclosure, but all of these improvements shall fall within a scope of the present disclosure.

What is claimed is:

1. A lens assembly, comprising:
a support base;
a lens barrel suspended at an inner side of the support base; and
an adjustment mechanism comprising an Auto Focus (AF) assembly, an Optical Image Stabilizer (OIS) assembly, an elastic sheet assembly, and a flexible connection plate disposed below the support base;
wherein the OIS assembly comprises an OIS circuit board disposed between the support base and the flexible connection plate; a sensor is provided at a center of the OIS circuit board; and the flexible connection plate comprises a first connection portion connected to the sensor.

2. The lens assembly as described in claim 1,
wherein a heat dissipation hole is formed in the first connection portion, and a first flexible connection structure is provided in the heat dissipation hole; and
wherein the flexible connection plate further comprises a first frame arranged at a periphery of the first connection portion, and a second connection portion arranged between the first frame and the first connection portion.

3. The lens assembly as described in claim 1, wherein the OIS circuit board is a planar FPC, and the flexible connection plate is made of a titanium-copper alloy material.

4. The lens assembly as described in claim 1,
wherein the AF assembly comprises an AF coil, an AF magnet and an AF circuit board;
wherein the OIS assembly further comprises an OIS magnet and an OIS coil;
wherein the support base has a mounting groove, and the AF magnet, the OIS magnet and the OIS coil are arranged in the mounting groove along a direction from top to bottom; and
wherein the AF coil is wound at a periphery of the lens barrel, and the AF circuit board is arranged at the support base.

5. The lens assembly as described in claim 4,
wherein the elastic sheet assembly comprises a first elastic sheet and a second elastic sheet arranged on an upper surface and a lower surface of the lens barrel, respectively; and each of the first elastic sheet and the second elastic sheet is connected to both the lens barrel and the support base; and
wherein the elastic sheet assembly is connected to the AF circuit board, the OIS assembly and the support base, respectively.

6. The lens assembly as described in claim 5,
wherein the AF magnet is arranged between the lens barrel and the support base, and the AF magnet is evenly distributed at a periphery of the lens barrel;
wherein the lens barrel comprises a first connection ring arranged at a center, and a cantilever distributed at a periphery of and at an outer wall of the first connection ring; and the cantilever is arranged corresponding to four corners of the support base; and
wherein a second flexible connection structure is provided between the cantilever and the support base.

7. The lens assembly as described in claim 6, wherein a portion of the cantilever adjacent to the support base is provided with an avoiding structure.

8. The lens assembly as described in claim 6,
wherein the OIS magnet and the OIS coil are arranged corresponding to the AF magnet, respectively; an OIS support is provided in a plane region enclosed by the OIS coil, and the OIS support is arranged at the OIS circuit board; and
wherein the OIS support comprises a second connection ring arranged at a periphery of the sensor, a first contact table connected to the second connection ring and arranged corresponding to the OIS coil, and a second contact table extending from the second connection ring to a region corresponding to a bottom of the support base.

9. The lens assembly as described in claim 6, wherein the first elastic sheet and the second elastic sheet have a same structure, which comprises a third connection ring connected to the first connection ring, a first connection arm connected between the first connection ring and the support base, and a second connection arm connected between the first connection ring and the cantilever.

10. The lens assembly as described in claim 1, further comprising a housing, wherein the housing comprises a first housing arranged outside the support base, and a second housing arranged below the first housing and configured to receive the OIS circuit board and the flexible connection plate; and a gasket is provided between the second housing and an edge of the flexible connection plate.
